(19) United States
(12) Patent Application Publication
(10) Pub. No.: US 2026/0204941 A1
(43) Pub. Date: Jul. 16, 2026

(54) Electric Tool

(71) Applicant: TECHWAY INDUSTRIAL CO., LTD., Taichung City (TW)

(72) Inventors: Chih-Hua HSU, Taichung City (TW); Cheh Chen CHENG, Taichung City (TW); Cheng Nan LIEN, Taichung City (TW); Hsin Chih SHIH, Taichung City (TW)

(21) Appl. No.: 19/018,777

(22) Filed: Jan. 13, 2025

(51) Int. Cl. H02J 7/96; B25F 5/02; H01M 10/48; H02J 7/47

(52) U.S. Cl. CPC H02J 7/96; B25F 5/02; H01M 10/486; H02J 7/47

(57) ABSTRACT

An electric tool comprises a main body formed with a main chamber and a battery chamber; a pin set, the pin set has a judgment pin disposed in the battery chamber; a motor unit disposed in the main chamber of the main body, having a motor, a processing unit and a judgment unit; and a battery pack with a predetermined voltage value, a conductive pin set is provided at one end to be electrically connected to the pin set, the conductive pin set is provided with an identity pin electrically connected to the judgment pin, the judgment unit is electrically connected to the judgment pin, the judgment unit detects a voltage value of the battery pack and transmits the voltage value to the processing unit, the processing unit is capable of switching different operating modes for the motor according to different voltage values provided by the battery pack.

### FIELD OF THE INVENTION

The invention relates to an electric tool, more particularly to an electric tool that can be equipped with battery packs of different voltages and capable of switching operating modes according to different voltages.

### DESCRIPTION OF THE RELATED ART

When using conventional electric tools, especially cordless handheld electric tools, it is required to provide an external battery pack to provide electric power to the electric tool through the battery pack so that a motor of the electric tool can be driven by the electric power of the battery pack to operate.

However, the battery packs used with conventional electric tools have a fixed voltage. Each electric tool can only be used with battery packs of the same voltage and same type. In addition to the limitation on the voltage of the battery pack, different electric tools also need to be used with corresponding battery packs, which means that battery packs of different voltages need to be purchased for matching and combination, causing inconvenience in use and inconvenience of purchasing different battery packs.

### SUMMARY OF THE INVENTION

One object of the invention is to provide an electric tool, the electric tool is capable of using battery packs of different voltages.

One object of the invention is to provide an electric tool provided with an identity pin capable of determining a type of a battery pack and switching to a corresponding operating mode when connected to the battery pack.

In order to achieve the above objects, the invention provides an electric tool, comprising:

a main body formed with a main chamber and a battery chamber;

a motor unit provided in the main chamber of the main body and having a motor, a processing unit and a judgment unit, the processing unit is electrically connected to the motor and the judgment unit;

a pin set provided in the battery chamber, the pin set has a judgment pin; and

a battery pack with a predetermined voltage value, a conductive pin set is provided at one end to be electrically connected to the pin set, the conductive pin set is provided with an identity pin electrically connected to the judgment pin; when the battery pack is installed in the battery chamber, the judgment pin is electrically connected to the identity pin, the judgment unit detects a voltage value of the battery pack and transmits the detected voltage value to the processing unit, the processing unit is capable of switching the motor to different operating modes according to different voltage values.

Thereby, when the battery packs of different voltages are inserted into the main body, the judgment pin can be connected to the identity pin, so that the processing unit is capable of judging a voltage value, and providing different operating modes to drive the motor, so that the electric tool can accept the battery packs of different voltages for operation.

Preferably, the processing unit switches operating modes of the motor by switching a torque value output by the motor; using the battery pack with a larger voltage can switch to a larger torque operation and improve an operation intensity. When using the battery pack with a smaller voltage, the processing unit switches the motor to an output of smaller torque/ normal torque.

The electric tool provided by the invention is capable of detecting the battery packs with different voltage values through the judgment pin, and using detection results of the judgment unit to cause the processing unit to switch to different operating modes for the motor. In addition to using the battery packs with different voltages, the electric tool is further capable of generating different operating modes by switching the battery packs with different voltages, thereby increasing a usability of the electric tool.

### BRIEF DESCRIPTION OF DRAWINGS

In order to enable the examiner to further understand the objects, features, and achieved efficacies of the invention, one preferred embodiment is described below for detailed explanation in conjunction with the drawings, in which:

FIG. 1 is a perspective view of a preferred embodiment of the invention.

FIG. 2 is a cross-sectional view of a preferred embodiment of the invention.

FIG. 3 is a cross-sectional view of assembly positions of a battery pack and a battery chamber of a preferred embodiment of the invention.

FIG. 4 is a perspective view of connection between the battery pack, a pin set and a processing unit of a preferred embodiment of the invention.

FIG. 5 is a detailed schematic diagram of connection between the battery pack and pins of a preferred embodiment of the invention.

FIG. 6 is a perspective view of a first battery pack of a preferred embodiment of the invention.

FIG. 7 is a perspective view of a second battery pack of a preferred embodiment of the invention.

FIG. 8 is a connection circuit block diagram of a preferred embodiment of the invention.

### DETAILED DESCRIPTION OF THE INVENTION

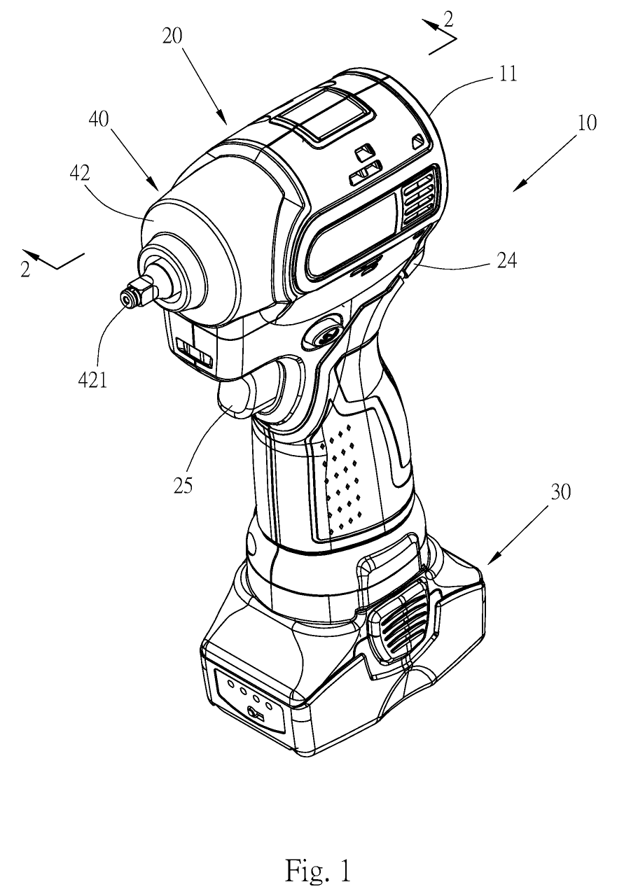

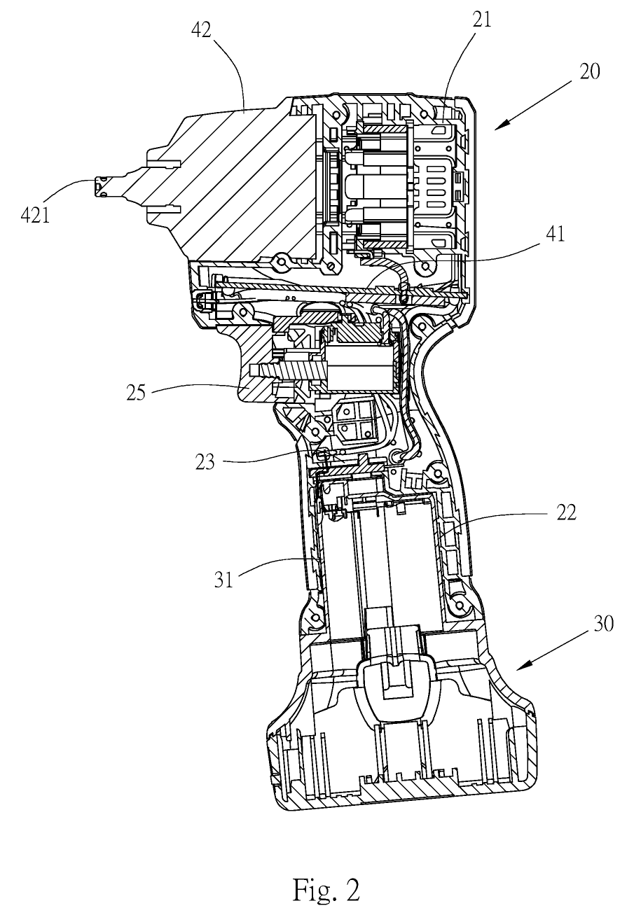

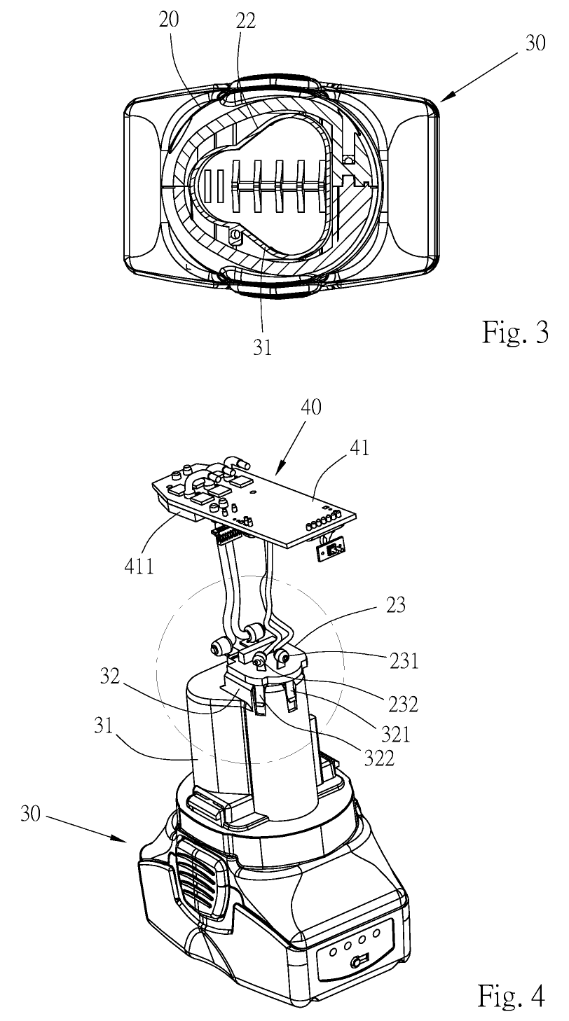

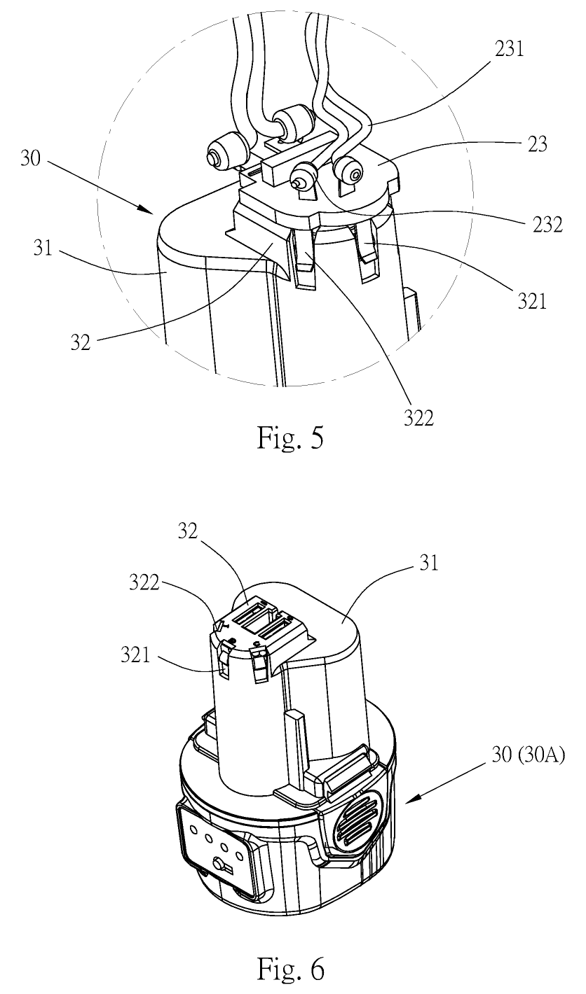

Please refer to FIGS. 1 to 8 for a preferred embodiment of an electric tool 10 provided by the invention. In this embodiment, the electric tool 10 is an electric wrench 11, but it can also be set as other types of electric tools as required, not limited to structures or scope of use thereof. Various types of electric tools, such as electric ratchet wrench, electric screwdriver, blind rivet tool, rivet nut tool, etc., can be applied. The electric tool 10 mainly comprises a main body 20, a battery pack 30, and a motor unit 40.

The main body 20 is formed with a main chamber 21 and a battery chamber 22. A pin set 23 is provided in the battery chamber 22, and the pin set 23 has a judgment pin 231 and a status detection pin 232. The main body 20 is further provided with a switch 24 and a trigger 25. The switch 24 can perform power on/ power off operations. The trigger 25 can perform a running operation. Pressing the trigger 25 can drive the electric wrench 11 to run. Settings of the switch 24 and the trigger 25 can be adjusted according to requirements, and types and usage methods thereof are not limited.

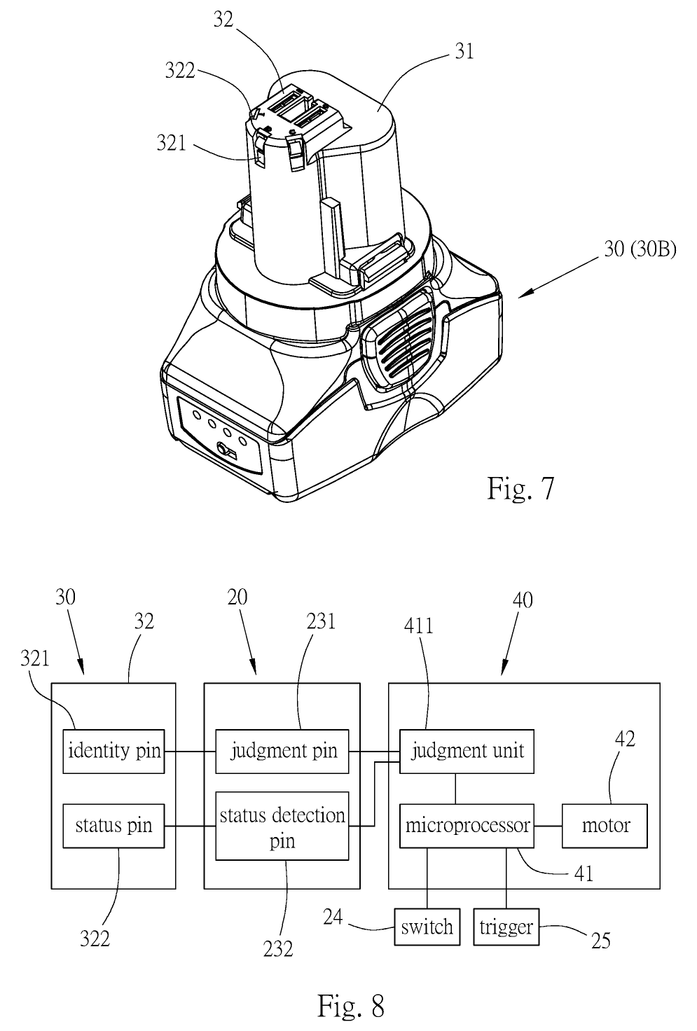

Please refer to FIGS. 6 and 7 for the battery pack 30. Each of the battery packs 30 has a predetermined voltage value. In this embodiment, its basic use is a first battery pack 30A, which has a basic voltage value. In addition, in order to use another voltage value, the first battery pack 30A can be replaced with a second battery pack 30B. As shown in FIG. 7, in this embodiment, a voltage value of the second battery pack 30B is greater than a voltage value of the first battery pack 30B. A top of the battery pack 30 is provided with an insertion portion 31 relative to the battery chamber 22, and a top of the insertion portion 31 is provided with a conductive pin set 32. The insertion portion 31 is placed in the battery chamber 22 to electrically connect to the pin set 23. The conductive pin set 32 is provided with an identity pin 321 electrically connected to the judgment pin 231 and a status pin 322 electrically connected to the status detection pin 232. When the judgment pin 231 is connected to the identity pin 321, the identity pin 321 is capable of providing a voltage value of the battery pack 30 through conversion or measurement. The identity pin 321 can also be designed to provide relevant information of the battery pack 30. In addition, when the status detection pin 232 is connected to the status pin 322, the status pin 322 can be sensed to obtain a current temperature status of the battery pack 30. Through high and low temperatures of the battery pack 30, it can be determined whether the battery pack 30 is suitable for power supply operation.

The motor unit 40 is disposed in the main chamber 21 of the main body 20 and has a processing unit and a motor 42. The processing unit can be a microprocessor 41 or other components with computing functions, such as a microcontroller. The motor 42 is an electric motor. In this embodiment, a front end of the motor 42 has a driving head 421 that can be directly connected with a socket or a screwdriver for driving, and can also be equipped with a ratchet head, a blind rivet tool or a rivet nut tool as required. The microprocessor 41 is electrically connected to the switch 24, the trigger 25 and the motor 42. The microprocessor 41 is also provided with a judgment unit 411 that is electrically connected to the pin set 23. In practice, the judgment unit 411 can also be directly installed in the microprocessor 41 as a single component. The judgment pin 231 of the pin set 23 can measure a voltage value of the battery pack 30 through the judgment unit 411 when the switch 24 is initially turned on, and transmit data to the microprocessor 41. The microprocessor 41 can make the motor 42 have different operating modes according to different voltage values of the battery pack 30 measured by the judgment unit 411. In this preferred embodiment, the judgment unit 411 can switch the motor 42 to a larger torque operating mode or a smaller torque/normal torque operating mode according to the voltage value of the battery pack 30. When using the second battery pack 30B with the larger voltage, the microprocessor 41 will switch the motor 42 to the larger torque operating mode. The judgment unit 411 can detect a temperature status of the battery pack 30 sensed by the status pin 322 at any time through the status detection pin 232. When the judgment unit 411 detects that a temperature of the battery pack 30 is too high, the judgment unit 411 can judge that the battery pack 30 is overheated, and the microprocessor 41 directly stops operation of the motor 42. When using the first battery pack 30A with the smaller voltage, the microprocessor 41 switches the motor 42 to the normal torque/smaller torque operating mode.

During use, the insertion portion 31 of the selected battery pack 30 (the first battery pack 30A or the second battery pack 30B is selected according to requirements) is inserted into the battery chamber 22 so that the pin set 23 can be electrically connected to the conductive pin set 32. Then, the switch 24 is turned on so that the judgment pin 231 can read a voltage value of the battery pack 30 through the identity pin 321 and detect a voltage value through the judgment unit 411. Then, the judgment unit 411 provides a detected voltage value to the microprocessor 41, so that the microprocessor 41 can switch the motor 42 to different torque modes for voltage values of the different battery packs 30 (30A, 30B). When the trigger 25 is pressed, the motor 42 will generate different torque output drives with different voltages.

A user can replace the battery pack 30 with different voltage values according to operation requirements. Under normal operating torque conditions, the first battery pack 30A can be used for operation; if a larger output torque operation is required, the first battery pack 30A can be replaced with the second battery pack 30B with the larger voltage, so that the microprocessor 41 can convert the torque of the motor 42 according to the battery pack 30 with different voltage values. When replacing the first battery pack 30A and the second battery pack 30B with different voltages, as long as the switch 24 is turned on again, the judgment unit 411 will re-judge the voltage value generated by the identity pin 321 of the battery pack 30 through the judgment pin 231, so that the microprocessor 41 can generate a corresponding voltage value operation to convert an operating torque of the motor 42. Furthermore, the first battery pack 30A and the second battery pack 30B with two different voltage values can be applied to the same electric tool 10. During judgment, it only needs to be judged once when the electric tool 10 is initially turned on by the switch 24. Operation process is simple and does not require waiting. In addition, when the electric tool 10 is in operation, the judgment unit 411 can be connected to the status pin 322 through the status detection pin 232 so that the judgment unit 411 can sense a current operating temperature of the battery pack 30. When a temperature of the battery pack 30 is too high due to long operation time, the microprocessor 41 can stop driving the motor 42 and stop the battery pack 30 from continuing to discharge to avoid damage caused by overheating.

In the electric tool provided by the invention, the judgment unit can directly judge a voltage value of the battery pack, and enable the microprocessor to convert the motor to generate different operating modes, enabling the electric tool to use a wider range of voltages, and the single battery pack can also be applied to different electric tools, increasing its versatility.

Although the invention has been disclosed as above with the embodiment, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is:

1. An electric tool comprising:
a main body formed with a main chamber and a battery chamber;
a motor unit provided in the main chamber of the main body and having a motor, a processing unit and a judgment unit, the processing unit being electrically connected to the motor and the judgment unit;
a pin set provided in the battery chamber, the pin set having a judgment pin; and
a battery pack with a predetermined voltage value, a conductive pin set being provided at one end thereof to be electrically connected to the pin set, the conductive pin set being provided with an identity pin electrically connected to the judgment pin; when the battery pack being installed in the battery chamber, the judgment pin being electrically connected to the identity pin, the judgment unit measuring a voltage value of the battery pack and transmitting the measured voltage value to the processing unit, the processing unit being capable of switching the motor to different operating modes according to different voltage values.

2. The electric tool as claimed in claim 1, wherein the processing unit switches operating modes of the motor by switching a torque value of the motor.

3. The electric tool as claimed in claim 1, wherein the pin set is provided with a status detection pin, the battery pack is provided with a status pin, the status detection pin is electrically connected to the status pin, and the status detection pin is connected to the judgment unit, a status of the battery pack is sensed through the status pin.

4. The electric tool as claimed in claim 3, wherein the judgment unit determines a status of the battery pack by sensing a temperature status provided by the status pin.

5. The electric tool as claimed in claim 1, wherein the battery pack has an insertion portion, the insertion portion is inserted into the battery chamber, and the conductive pin set is disposed on a top surface of the insertion portion.

6. The electric tool as claimed in claim 1, wherein the main body is provided with a switch, the switch is connected to the processing unit, when the switch is turned on, the judgment unit can be driven to connect to the identity pin through the judgment pin to determine a voltage value of the battery pack.
